(19) United States
(12) Patent Application Publication
(10) Pub. No.: US 2007/0051245 A1
(43) Pub. Date: Mar. 8, 2007

(54) Wet type air purification apparatus utilizing a centrifugal impeller

(76) Inventor: Jangshik Yun, Daejeon (KR)

Correspondence Address: IPLA P.A., 3580 WILSHIRE BLVD., 17TH FLOOR, LOS ANGELES, CA, 90010, US

(21) Appl. No.: 10/595,460

(22) PCT Filed: Feb. 3, 2005
(86) PCT No.: PCT/KR05/00324

§ 371 Date: Apr. 20, 2006

(51) Int. Cl. B01D 47/00

(52) U.S. Cl. 96/281

(57) ABSTRACT

This invention relates to a wet type air cleaner utilizing a centrifugal impeller with an electric motor instead of using filters, thus the separation of particular dust, mist can be absolutely eliminated from air with the difference of specific gravity between gas and pollution liquid under centrifugal force. An wet type air cleaner utilizing a centrifugal impeller comprising: protection grill (400) and water tank (401) located on an inlet pipe (405), an electric motor (433) with a centrifugal impeller (408) and a bearing (434) located inside of centrifugal cleaner (407), a drain trap (441) and humidity controller (442) installed on an exit pipe (432) etc. Therefore centrifugal wet type air cleaner make fresh air efficiently to be carried out by centrifugal force without using filters in the field of home, office, passenger car, dust place like cement factory, machine center, exhaust gas cleaner for an industrial burner and an internal combustion engine.

### TECHNICAL FIELD

This invention relates to a wet type air cleaner utilizing a centrifugal impeller for clean gas, especially “fresh air”, thus the separation of pollution substances with scrubbing liquid can be absolutely eliminated from air with utilizing the difference of specific gravity (approximately 1:1000) as in air and liquid on the basis of centrifugal force in the vortex generating structure such as centrifugal impeller and spiral grooves, since scrubbing the pollution substances including fine particle(less than 0.01□) of dust, harmful gases, virus and bacteria in air with the positive three dimensional vortex stream of fine water droplets(0.3□), such as mist and fog, on the basis of aqua viscous cohesion with liquid droplet, especially “natural water droplets” instead of using solid filters.

### BACKGROUND ART

The disadvantages of the known air cleaner are classified with the following type;

Filter: it has a problem with low purification efficiency due to clogging of pollution dust, unsanitary germ culture, occurring in series of junk pollution material for environment,

Negative ion: it has a problem with generation of harmful gas, ozone (O₃),

Conventional water filter: it has a problem with low cleaning efficiency due to passive water surface contact, i.e. two dimensional scrubbing, scrubbing contact part of pollution substances only, high humidity with lot of water evaporation, as a result, the corrosion of electronic product, filling water frequently, and needs for germicidal chemicals,

Ultra violet rays Beam: it has a unpractical problem with low air purification efficiency exept sterization of germ,

Low temperature plasma: it has a serious problem with high electric voltage, 5000-12000V, thus it is unsafe home appliance.

Hereafter especially conventional water filter appliances for purifying and/or humidifying gases, especially room air, are known, U.S. Pat. No. 4,829,781; in particular, attention is drawn to the possibility of air purification and humidification by means a plate stack rotating in a liquid with installing air cooler, or refrigerator for dehumidifying air on the basis of low dew point. Also, water filter air cleaner has still best quality air purification efficiency worldwide comparing with solid hepa filter, negative ion, low plasma et al. However it has a problem with low cleaning efficiency due to passive water surface contact, i.e. two dimensional scrubbing, scrubbing contact part of pollution substances only, high humidity with lot of water evaporation, as a result, the corrosion of electronic product, filling water frequently, and needs for germicidal chemicals as described above.

### DISCLOSURE OF INVENTION

Technical Problem

Especially, the conventional water filter air cleaner on the basis of U.S. Pat. No. 4,829,781 has problem with low cleaning efficiency due to passive two dimensional water surface contact, scrubbing contact part of pollution substances only, high humidity with lot of water evaporation, as a result, the corrosion of electronic product, refilling water frequently, and Adding pasteurization chemicals.

Technical Solution

Wet type air cleaner utilizing a centrifugal impeller is to eliminate the disadvantages mentioned above and to provide an advantage appliance with aqua viscous cohesion of fine water droplets in the positive three dimensional vortex flow, neutralization reaction with harmful gaseous substances, centrifugal separating on the basis of different specific density, especially air: water 1:1,000, automatic sterilization without pasteurization chemicals according to this invention.

It is composed of atomizer for generating Fine water droplets(0.3□) as in the vortex flow on the basis of positive 3 dimensional scrubbing with aqua viscosity cohesion, gas-liquid centrifugal separator for preventing a high humidification problem with utilizing the different specific density (1:1,000, air: liquid, especially water), and liquid circulation pump for reusing liquid for a long time without frequently refilling. Wherein the sort of atomizer comprises aerodynamic venturing tube, ultra sonic vibration, air-water nozzle with blower or compressor.

Advantageous Effects

Wet type air cleaner utilizing a centrifugal impeller with a liquid sprayer and gas-liquid centrifugal separator for cleaning gases, especially air is achieved for more than 99% air purification efficiency with the aqua viscous cohesion of fine water droplets in the positive 3 dimensional vortex flow, neutralization reaction with harmful gaseous substances, centrifugal separating on the basis of different specific density, especially air: water 1:1000, automatic sterilization without chemical addicts due to strong centrifugal separation and impinge effect.

This apparatus is based on numerous fine droplets of natural water in three dimensional vortex stream for scrubbing pollution substances positively, thus it is advantages of no more succession yields of junk pollution material such as an abolished solid filter.

As a result, it is applicable for fresh air in hospital facility including baby room, aseptic surgery, and patient room, automobile, home appliances, office, and school, and industrial facility for semi conduct manufacturing, chemical process, clean room, aseptic laboratory, and military tools for chemical, biological and radiological (CBR) warfare including a personal soldier, a bunker, a tank et al.

Further The gas-liquid centrifugal separator may be provided for an auxiliary part of a complex air cleaner or air condition system.

This Wet type air cleaner utilizing a centrifugal impeller is compared with a conventional air cleaner, especially a conventional water filter as in the following comparison table. Since the conventional water filter air cleaner has still the best quality of air purification efficiency worldwide comparing with solid hepa filter, negative ion, low plasma et al.

TABLE 1

| comparison | convensional | |
|---|---|---|
| apparatus | water filter | the present invention |
| Scrubbing | 2 dimension Water | aqua viscous cohesion |
| principle & | surface contact, | with numerous fine water |
| mechanism | pollution substances | droplets in 3 dimension |
| | contact part only | vortex stream, 99.9% |
| | less than 85% | scrubbing efficiency |
| | scrubbing efficiency | also, 99.9% centrifugal |
| | | gas-liquid separation |
| humidity | expensive cost with | Centrifugal separation |
| problem with | air cooler, or lot | 99.9%, discharging dry |
| evaporation | of water Evaporation, | air, low humidity, no |
| of water | High humidity refilling | problem refilling |
| | frequently, daily | monthly |
| scrubbing of | 30-65% impossible | 99.9% with |
| Harmful gases | | netralization reaction |
| CBR warfare for | | perfect possible |
| military use | | |
| Air | no more than 85% | 99.9% with |
| purification | adding sterization | netralization with |
| efficiency | chemical | natural water H₂O |
| | | automatic sterization |

### BRIEF DESCRIPTION OF THE DRAWINGS

FIG. 1 is a perspective view for schematically showing a gas-liquid centrifugal separator according to the present invention;

FIG. 2 is an upper side view of operation for schematically showing a centrifugal impeller according to the present invention;

FIG. 3 is an lateral view of operation for schematically showing a centrifugal impeller according to the present invention;

FIG. 4 is an illustrative view of another embodiment for schematically showing a centrifugal impeller according to the present invention;

FIG. 5 is a perspective view for schematically showing spiral grooves for generating vortex according to the present invention;

FIG. 6 is an layout view for schematically showing wet type air cleaner according to the present invention;

FIG. 7 is a B-B cross sectional view for schematically showing a 1^{st} vortex room in FIG. 1;

FIG. 8 is a C-C cross sectional view for schematically showing a 2nd vortex room in FIG. 1;

FIG. 9 is a D-D cross sectional view for schematically showing a separated liquid passage holes in FIG. 1;

FIG. 10 is a perspective view of another embodiment for an air purification apparatus utilizing a centrifugal impeller according to the present invention;

FIG. 11 is an A-A cross sectional view for schematically showing air inlet and outlet pipe in FIG. 10;

FIG. 12 is a perspective view of another embodiment for a mobile harmful dust purification apparatus according to the present invention;

FIG. 13 is a perspective view of another embodiment for a chimney exhaust gas purification apparatus according to the present invention;

FIG. 14 is a perspective view of another embodiment for an automobile turbo charger suction air purification apparatus according to the present invention;

FIG. 15 is a perspective view of another embodiment for an automobile exhaust gas purification apparatus according to the present invention;

Mark for major part of figure;

403: atomizer 407: gas-liquid centrifugal separator

408: centrifugal impeller 416: spiral grooves

433: electric motor 441: liquid trap

### BEST MODE FOR CARRYING OUT THE INVENTION

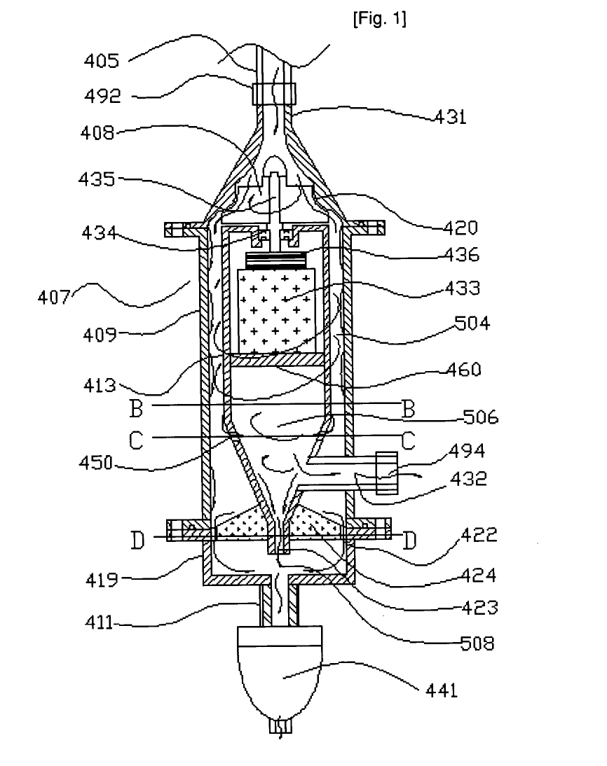

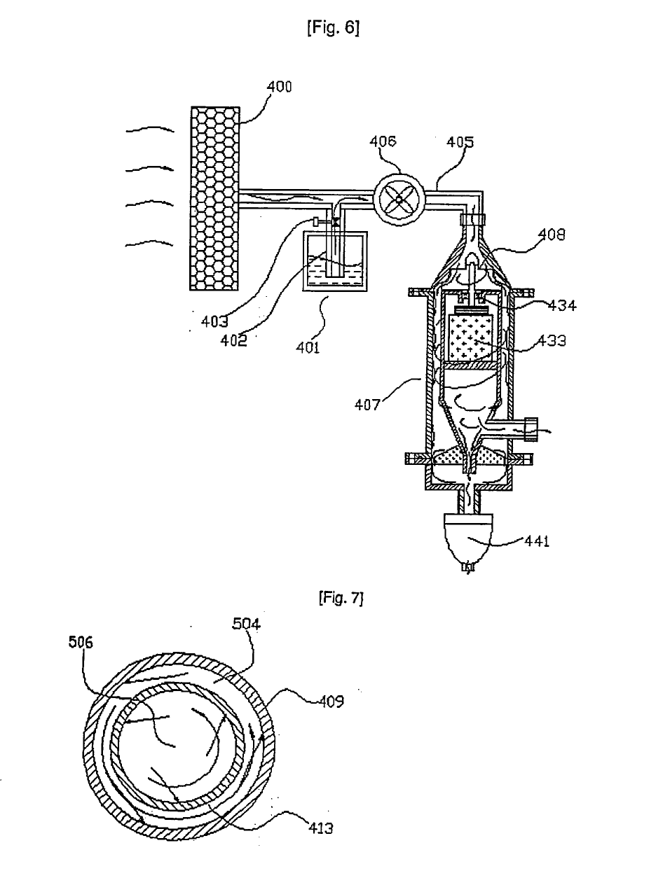

As shown in FIG. 1 and FIG. 6, eller shaft 435 and disposed inside of a shroud 420 at a gas suction inlet 431, a bearing 434 supported with a an impeller shaft 435 for a centrifugal impeller 408, an over driver 436 installed on an electric motor 433, a liquid atomizer 403 and a grill 400 disposed on the front of a gas-liquid centrifugal separator 407 through a gas suction duct 405, a liquid tank 401 disposed with a liquid atomizer 403 through a venturing tube 402, a gas passage cylinder 413 disposed for fastening an electric motor 433 inside of a gas-liquid centrifugal separator 407, gas passage holes 450 formed on the circumference side of a gas passage cylinder 413, a separate plate 460 installed inside of a gas passage cylinder 413, a liquid drain plate 424 is installed on the bottom of a gas exhaust cylinder 413, a first liquid drain holes 422 formed on a liquid drain plate 424, a second liquid drain holes 423 formed on a liquid drain plate 424, a liquid drain vessel 419 disposed on the bottom of a gas passage cylinder 413, a frain room formed inside of a liquid drain vessel 419, a liquid drain trap 441 disposed on the bottom of a liquid drain vessel 419 through a liquid drain pipe 411, and a first vortex room 504 provided annually inside of a housing 409, a second vortex room 506 provided inside of a gas passage cylinder 413;, and a gas-liquid centrifugal separator 407 used for a dehumidification apparatus as an accessory parts in complex type air cleaner or air condition system;

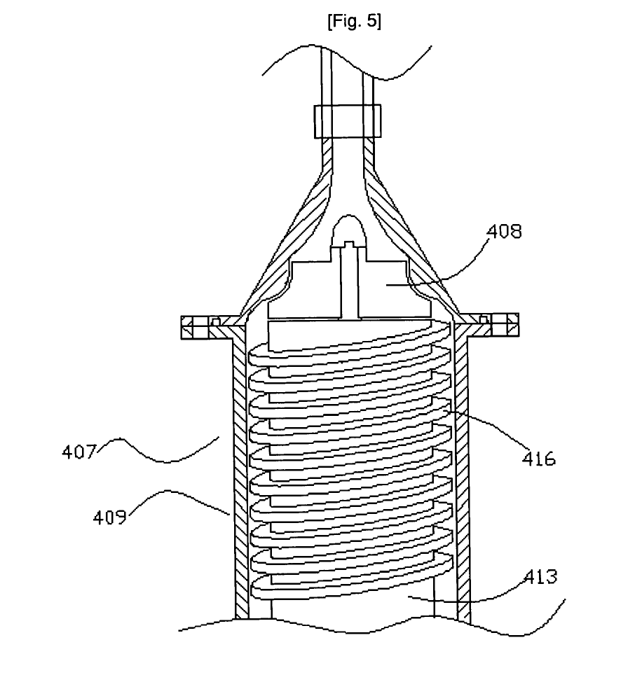

As shown in FIG. 5, comprising: spiral grooves 416 formed on the outside surface of a gas passage cylinder 413 for generating centrifugal vortex stream;

As shown in FIG. 1, an over driver 436 utilized with the various transfer means including an oil surface friction transmission, a gear transmission et al. for increasing the rotation speed of a centrifugal impeller 408;

As shown in FIG. 4, a centrifugal impeller 408 coupled with a stream guide 408A for generating strong vortex stream on the basis of low fluid friction resistance;

As shown in FIG. 6, a humidity controller 442 installed on a clean gas outlet 432 for adjusting the humidity of fresh gas;

As shown in FIG. 6, a liquid atomizer 403 utilized with the various atomizing means including a venturing tube, an ultra sonic vibration generator, and an air-liquid jet nozzle et al., and a liquid atomizer 403 installed with a liquid circulation pump disposed from a liquid drain trap 441 to a liquid tank 401 through a liquid pipe, and a liquid atomizer 403 installed with vortex generating means for generating a strong vortex stream of fine liquid droplet inside of gas suction duct 405;

As shown in FIG. 1, a centrifugal impeller 408 utilized with a turbine impeller for generating centrifugal vortex stream in a gas-liquid centrifugal separator 407;

As shown in FIG. 10, Wet type air cleaner utilizing a centrifugal impeller with a liquid atomizer and a gas-liquid centrifugal separator for disposing an electric motor outside of a gas-liquid centrifugal separator, comprising: an electric motor 433 installed on the outside of a gas-liquid centrifugal separator 407, an over driver 436 connected with an electric motor 433, an impeller shaft 435 rotatably fixed with an over driver 436, a centrifugal impeller 408 rotatably fixed on an impeller shaft 435, and a bearing 434 supported for a centrifugal impeller 408 on a gas passage cylinder 413;

As shown in FIG. 10, an impeller shaft 435 formed with an gas passage inside for passing a clean gas through inside of a shaft;

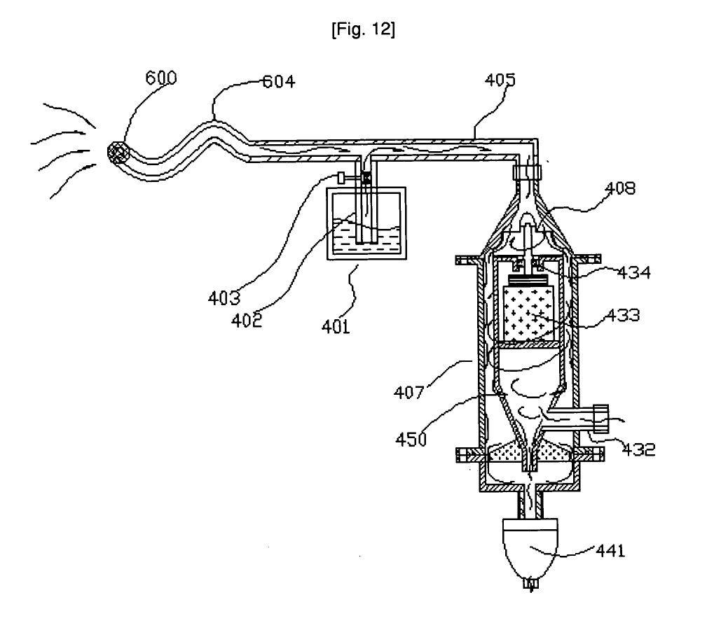

As shown in FIG. 12, Wet type air cleaner utilizing a centrifugal impeller with a liquid atomizer and a gas-liquid centrifugal separator for scrubbing dust and harmful gases at a remote distance, comprising: a flexible hose 604 connected with a liquid atomizer 401 in the front of an gas-liquid centrifugal separator 407 through a gas inlet duct 405;

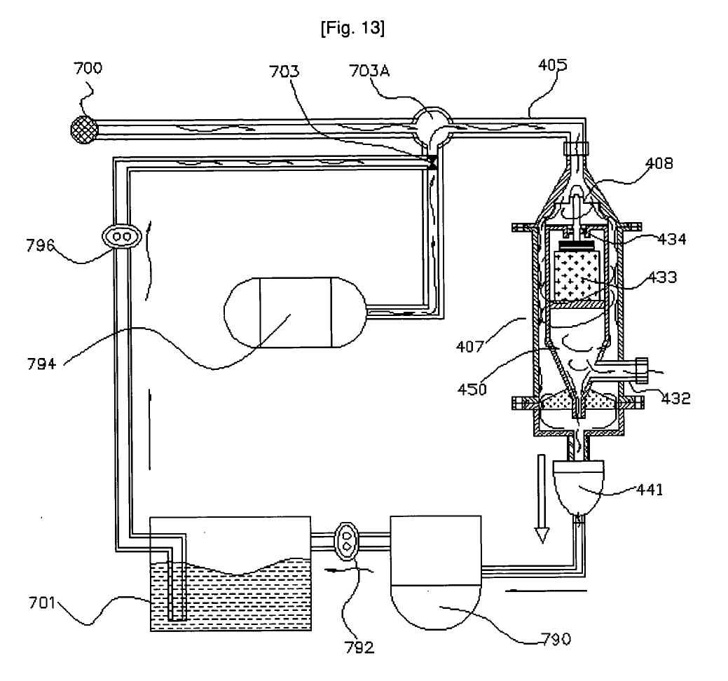

As shown in FIG. 13, Wet type air cleaner utilizing a centrifugal impeller with a liquid atomizer and a gas-liquid centrifugal separator for cleaning the exhaust gas of chimney in industrial facility, comprising: a vortex cleaning room 703A disposed in the front of a gas-liquid centrifugal separator 407 through a gas suction duct 405, and a liquid atomizer 703 connected with a vortex cleaning room 703A through a pipe, an air blower 794 connected with a vortex cleaning room 703A through a pipe for operating an air-liquid jet nozzle, and a liquid supply pump 796 connected with a vortex cleaning room 703A through a liquid pipe, a liquid tank 701 connected with a liquid supply pump 796 through a liquid pipe, a liquid circulate pump 792 connected with a liquid tank 701 through a liquid pipe, a liquid cleaner 790 connected with a liquid circulate pump 792 through a liquid pipe, a liquid drain trap 441 connected with a liquid cleaner 790;

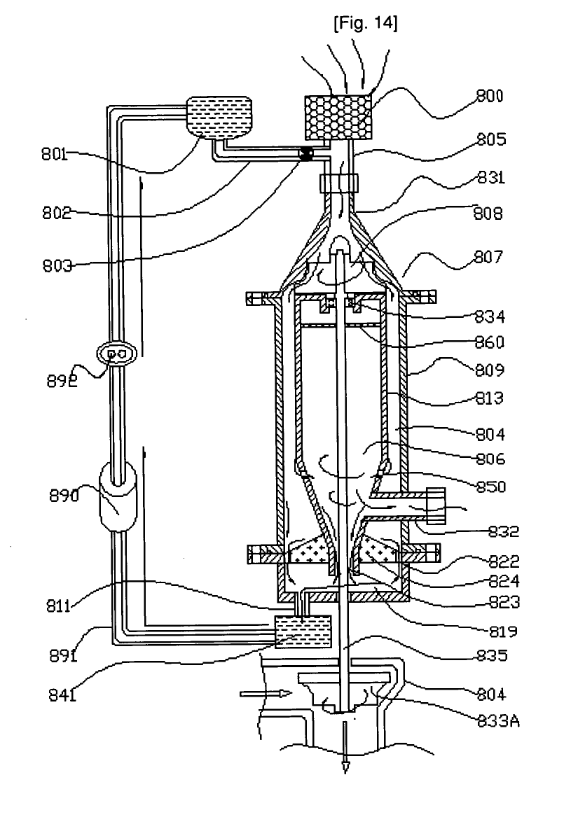

As shown in FIG. 14, Wet type air cleaner utilizing a centrifugal impeller with a liquid atomizer and air-liquid centrifugal separator for cleaning the suction air of a turbo charger in an automobile engine, comprising: an air-liquid centrifugal separator 807 disposed with a grill 800 at the air inlet of an engine, a centrifugal impeller 808 supported with a bearing 834 inside of a an air-liquid centrifugal separator 807, a turbine 833A connected with a centrifugal impeller 808 through an impeller shaft 835, a liquid atomizer 803 disposed in the front of an air-liquid centrifugal separator 807 through an air suction duct 805, an air passage cylinder 813 disposed inside of an air-liquid centrifugal separator 807, several air passage holes 850 formed on the circumference side of an air passage cylinder 813, a clean air outlet 832 installed on the side of an air passage cylinder 813, a liquid drain plate 824 is installed on the bottom of a gas exhaust cylinder 813, a first liquid drain holes 922 formed on a liquid drain plate 824, a second liquid drain holes 823 formed on a liquid drain plate 824, a liquid drain trap 841 installed on the bottom of a liquid drain vessel 819, and a first vortex room 804 formed annually inside of a housing 809, a second vortex room 806 formed inside of an air passage cylinder 813, and a liquid filter 890 connected with a liquid drain trap 841 through a liquid pipe 891, a circulate pump 892 connected with a liquid filter 890 through a liquid pipe 891, a liquid tank 801 connected with a circulate pump 892 through a liquid pipe 891, a liquid atomizer 803 connected with a liquid tank 801 through a liquid pipe 891;

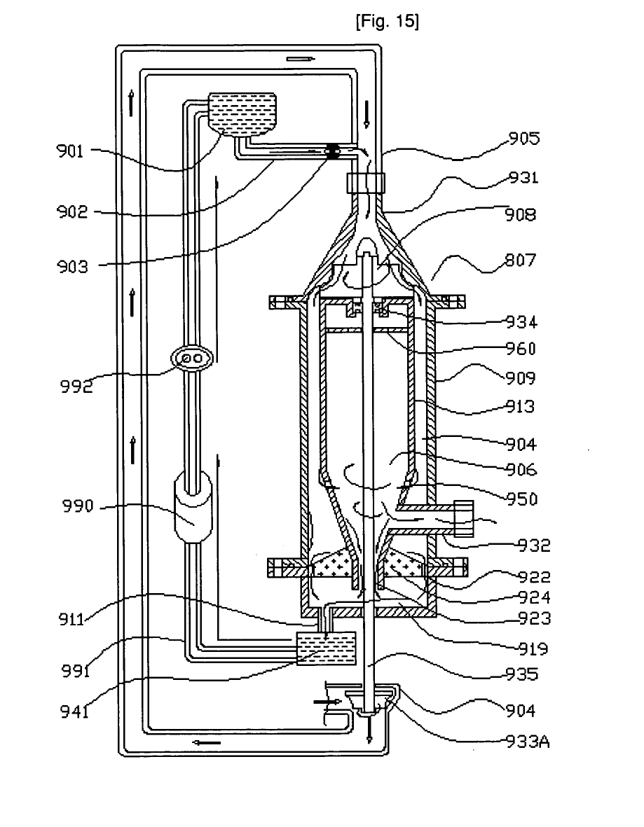

As shown in FIG. 15, with a bearing 934 inside of a gas-liquid centrifugal separator 907, a turbine 933A connected with a centrifugal impeller 908 through an impeller shaft 935, a liquid atomizer 903 disposed in the front of a gas-liquid centrifugal separator through an exhaust gas suction duct 905, a gas passage cylinder 913 located inside of a gas-liquid centrifugal separator, several gas passage holes 950 formed on the circumference side of a gas passage cylinder 913, a clean gas outlet 932 installed on the side of a gas exhaust cylinder 913, a liquid drain plate 924 is installed on the bottom of a gas exhaust cylinder 913, a first liquid drain holes 922 formed on a liquid drain plate 924, a second liquid drain holes 923 formed on a liquid drain plate 924, a liquid drain vessel 919 disposed on the bottom of a gas passage cylinder 913, a liquid drain trap 941 installed on the bottom of a liquid drain vessel 919, and a first vortex room 904 formed annually in a housing 909, a second vortex room 906 formed inside of an exhaust gas passage cylinder 913, and a liquid filter 990 connected with a liquid drain trap 941 through a liquid pipe 991, a liquid circulate pump 992 connected with a liquid filter 990 through a liquid pipe 991, a liquid tank 901 connected with a circulate pump 992 through a liquid pipe 991, a liquid atomizer 903 connected with a liquid tank 901 through a liquid pipe 991.

The present invention has been cited with reference parts and numbering based on 20-0328651: the ROK registration No. of utility model, “centrifugal type of air cleaner”, application laid-open No. 10-2004-0043138: “air cleaner utilizing a centrifugal impeller”, and application laid-open No. 10-2004-0043138: “air cleaner utilizing a centrifugal impeller” assigned with same applicant and inventor, YUN, Jangshik.

Mode for the Invention

Best Mode for Carrying Out the Invention Preferred embodiments of the present invention will be explained hereafter with reference to accompanied embodiments.

As shown in FIG. 1, Air purification apparatus utilizing a centrifugal impeller with aid of the rotation power of an electric motor for separating centrifugally liquid including pollution substances from gas, especially air, a gas-liquid centrifugal separator 407 is disposed with coupling a gas suction duct 405 with a fastener 492, an electric motor 433 located on gas passage cylinder 413 inside of gas-liquid centrifugal separator 407, centrifugal impeller 408 rotably fixed at a gas suction inlet 431 on an electric motor 433 through an impeller shaft 435 with installation of an over driver 436.

Wherein said over driver 436 may be provided for increasing the speed of a centrifugal impeller 408 in the case of installing with a low rotation speed of an electric motor.

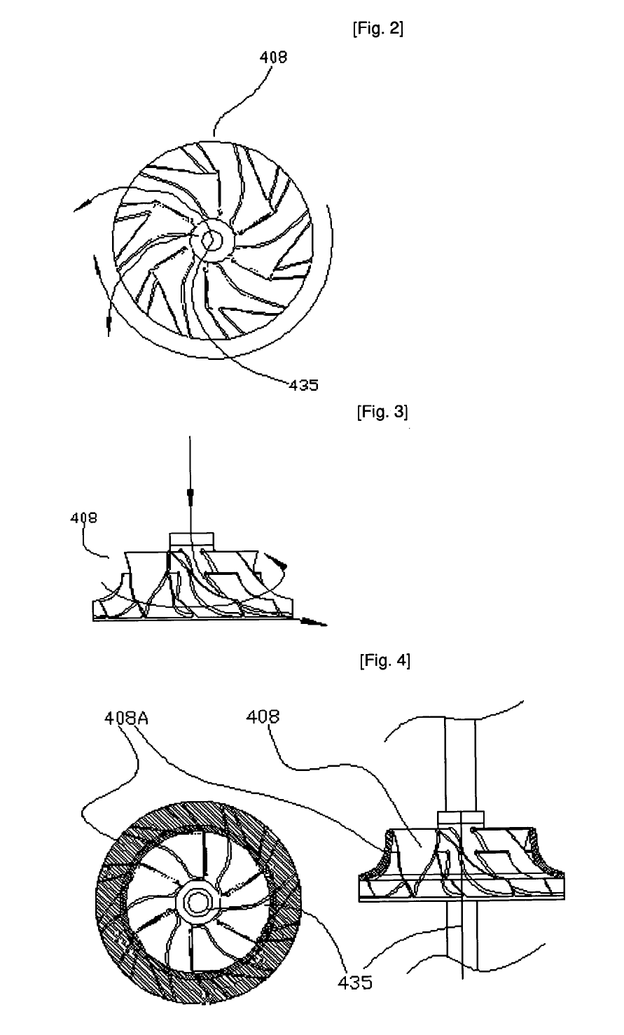

As shown in FIG. 2 and FIG. 3, a centrifugal impeller 408 is fixed on an electric motor 433 through an impeller shaft 435, and a centrifugal impeller 408 may be installed on an over driver 436 for spinning higher rotation speed even in a low speed of an electric motor, thus centrifugal vortex stream is generated with the rotation of an impeller shaft 435, as indicated by the arrows.

As shown in FIG. 4, said centrifugal impeller 408 may be coupled with fluid guide 408A for reducing fluid friction and pressure loss with the structure of a shroud 420 aerodynamically, thus centrifugal impeller 408 coupled with fluid guide 408A may be utilized for improving centrifugal separation effect, and the blade end of said centrifugal impeller 408 may be designed with a right angle, 90 degree for generating strong centrifugal gas stream, further centrifugal impeller 408 may be replaced with a turbine impeller for the purpose of generating centrifugal gas stream inside of a gas-liquid centrifugal separator 407.

As shown in FIG. 5, a gas passage cylinder 413 is formed with spiral grooves 416 on the outside circumference surface for improving the effect of centrifugal vortex gas stream along spiral grooves 416 and for passing downward separated liquid containing pollution substances with the labyrinth effect at a la vortex room 504 inside of a housing 409. Wherein vortex gas stream is formed along spiral grooves 416 on the basis of the labyrinth effect.

As shown in FIG. 6, a grill 400 usually called ‘pre filter’ is disposed in the front of a gas-liquid centrifugal separator 407 for preventing large grain in gas, and atomizer 403 is disposed for scrubbing pollution substances including fine particle (less than 0.01□) of dust, bacteria, virus, mist, mite, cigarette smoke, harmful gas with atomizing liquid, especially natural water (H₂O), also a liquid tank 401 may be used with adding scrubbing chemicals in liquid in the special case of pollution substances in gas, Wherein the atomization means of an atomizer 403 may be operated with various type including aerodynamic venturing tube, ultrasonic vibration, and gas-liquid nozzle with blower or compressor.

Therefore a centrifugal impeller 408 is rotated with the power of an electric motor 433 inside of a gas-liquid centrifugal separator 407,a gas stream is passed in a liquid atomizer 403 through a gas suction duct 405 via a grill 400, and then liquid, especially water is atomized or sprayed by the aerodynamic pressure from a lquid tank 401 through venturing tube 402 as indicated by the arrows, also atomization controller 402 is provided for adjusting the quantity of liquid atomization, wherein the numerous atomizing liquid droplets as in the flow of fog or mist may be formed with centrifugal vortex flow for effectively scrubbing the pollution substances of gas in gas suction duct 405. Wherein the pollution substances of gas are scrubbed efficiently with the viscous cohesion of liquid mist or fine aqua droplets in the three-dimensional cubic vortex flow as in a form of fog or mist.

Further, As shown in FIG. 1, the gas stream mixed with the atomized liquid droplets is flowed inside of a gas-liquid centrifugal separator 407 through a gas suction inlet 431 and gas suction duct 405 with the suction power of centrifugal impeller 408 rotating by the power of electric motor 433 as indicated by the arrows, thus the mixed gas-liquid stream is formed as centrifugal vortex stream after passing a liquid atomizer 403 through a gas suction duct 405. thus the mixed gas-liquid stream is distributed evenly with the inlet structure of spiral grooves 416, as indicated by the arrows as shown in FIG. 5, thus it is formed with a centrifugal vortex gas stream along spiral grooves 416 on the basis of the labylinth effect, meanwhile separated liquid including pollution substances is passed downward at a 1^{st} vortex room 504 between the spiral grooves 416 and the inner wall of a housing 409. Wherein a gas suction inlet 431 is connected with a gas suction duct 405 through a fastener 492.

Therefore, as shown in FIG. 7, the liquid is separated with pollution substances from gas stream with centrifugal force due to the different specific gravity of gas and liquid at a first vortex room 504 between the outside of spiral grooves 416 and the inside wall of a housing 409, as indicated by the arrows. Thus the liquid containing pollution substances is flowed downward with gravity effect on the inside wall of a housing 409. Further the liquid containing pollution substances is gathered with gravity effect at a liquid drain trap 441 through plurality of liquid drain holes 422 formed on a liquid drain plate 424 as shown in FIG. 9. Wherein said a liquid drain trap 441 is provided for discharging liquid containing pollution substances only but not gas, and the operation mechanism of a liquid drain trap 441 is not explained here since it is well known commercial pneumatic products in industrial parts.

Meanwhile, As shown in FIG. 7, the gas stream is passed as centrifugal flow for eliminating fluid containing pollutant substances at a first vortex room 504 inside wall of housing 409 along the circumference side of a gas passage cylinder 413, as indicated by the arrows. wherein spiral grooves 416 are formed for efficiently generating vortex stream on the surface of a gas passage cylinder 413 as shown in FIG. 5.

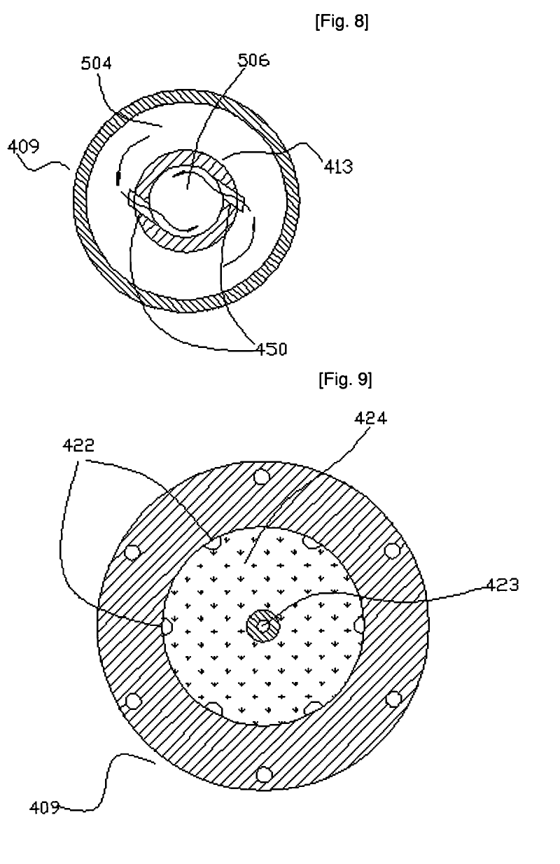

As shown in FIG. 8, a gas is flowed in at a second vortex room 506 as centrifugal vortex flow for eliminating the rest of liquid from gas once more through the plurality of gas passage holes 450 on the wall of a gas passage cylinder 413, as indicated by the arrows, thus the small amount of extra liquid is drained once more through a second liquid drain hole 423. Therefore clean gas, especially ‘fresh air’, is discharged through a clean gas outlet 432. Wherein humidity controller 442 is installed with adding aroma perfume et al. on a clean gas outlet 432 for adjusting humidity of a clean dry air.

As shown in FIG. 9, plurality of liquid drain passages 422 are formed on a liquid drain plate 424 on the bottom of a housing 409 for draining the centrifugal separated liquid containing pollutant substances at a first vortex room 504 inside of a housing 409, also a second liquid drain hole 423 is formed on a liquid drain plate 424 on the bottom of a gas passage cylinder 413 for draining the centrifugal separated liquid containing pollutant substances at a second vortex room 506 inside of a gas passage cylinder 413.

As described in above statement, the gas stream mixed with the atomized liquid droplets is flowed inside of a gas-liquid centrifugal separator 407 with an electric motor 433, and then the mixed gas-liquid stream is formed in the flow of centrifugal vortex, further the mixed gas-liquid stream is separated liquid containing pollution substances on the basis of different specific gravity (1:1000, gas:liquid, especially water) at a 1^{st} vortex room 504 and a 2^{nd} vortex room 506.

Therefore, the liquid containing pollution substances is flowed on the inner wall surface of a housing 409 due to aqua viscosity and gravity effect, wherein the liquid containing pollution substances may be not blown out or mixed again with the gas stream on the basis of aqua viscosous cohesion phenomenon.

Finally the liquid containing pollution substances is gathered with gravity effect at a liquid drain trap 441 from a liquid drain room 508 through a liquid drain pipe 411, meanwhile the clean gas, especially ‘fresh air’, is discharged in air through a clean gas outlet 432 without leaking air through a liquid drain trap 441.

Further a liquid circulation pump may be disposed on a liquid circulation pipe connected with a liquid atomizer 403 and a liquid drain trap 441 for circulating and reusing liquid, thus it is not required with frequently refilling liquid in a liquid tank 401. thus a liquid atomizer 403 may be installed with a liquid circulation pump disposed from a liquid drain trap 441 to a liquid tank 401 through a liquid pipe.

Wherein said atomizer 403 is provided for atomizing fine liquid droplets as in a vortex flow with various type including a venturing tube, an ultra sonic vibration, a water-air nozzle with blower or compressor. Thus fine liquid droplets, especially water droplets (0.3□) is generated in the vortex flow with said atomizer 403 for scrubbing fine particles and neutralizing harmful gaseous substances on the basis of 3 dimensional aqua viscosous cohesion.

Wherein the liquid of said atomizer 403 is is not required with sterilization chemicals due to automatic sterilization on the basis of strong centrifugal separation inside of said gas-liquid centrifugal separator 407.

Wherein said gas-liquid centrifugal separator 407 may be used for a dehumidification apparatus as an accessory parts in complex type air cleaner utilized with the combination of a solid filter, a conventional water filter, a negative ion type, and a low plasma type, also air condition apparatus.

Wherein said a gas-liquid centrifugal separator 407 may be used with automatic feed back system including air sensor, rpm sensor et al. for saving electric energy and adjusting humidity on the basis of the optimization operation of air purification.

Wherein said gas-liquid centrifugal separator 407 has a low noise structure with twofolds wall, since an electric motor 433 is located inside of gas passage cylinder 413 and housing 409 on the basis of double wall structure.

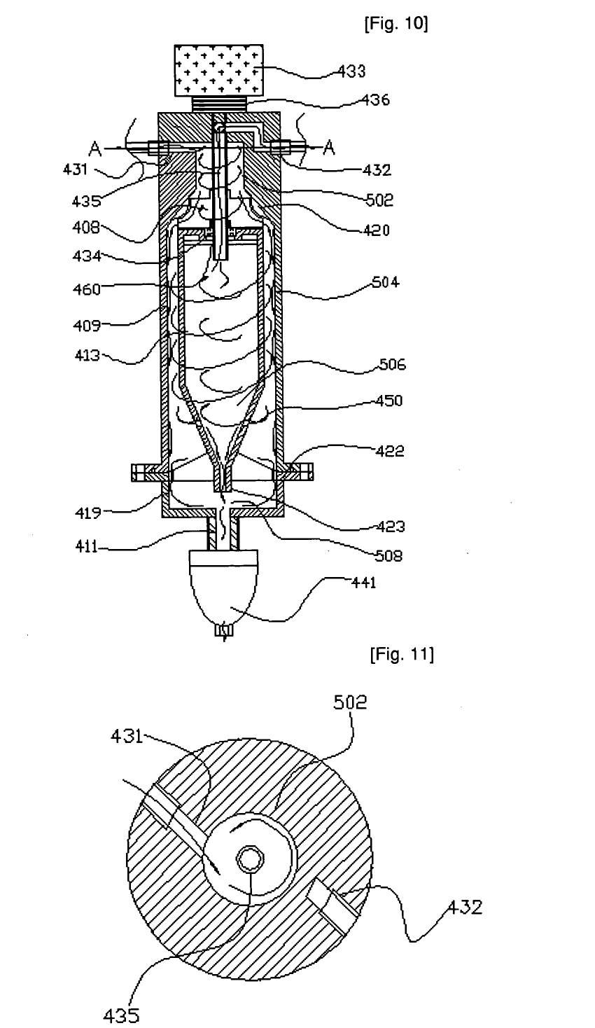

As shown in FIG. 10 and FIG. 11, a gas suction inlet 431 disposed on a gas entrance room 502 on an air-liquid centrifugal separator 407, an electric motor 433 disposed outside of an air-liquid centrifugal separator 407 for providing the whirl space of a vortex gas stream, also an over driver 436 installed on the bottom side of an electric motor 433 outside of an air-liquid centrifugal separator 407, an impeller shaft 435 rotatebly fixed on an electric motor 433 through an over driver 436, a centrifugal impeller 408 fixed on an impeller shaft shaft 435, and a bearing 434 fixed on a gas passage cylinder 413 for supporting a centrifugal impeller 408, especially large size of appliance for the industrial semi conduct manufacturing, chemical process, clean room, aseptic laboratory, and military facility with upgrading performance, gas clean efficiency. thus the mixed gas stream containg a pollution substances is flowed with gas passeges including the narrow space, circumferece gap of an impeller shaft 435 and an shroud 420, a first vortex room 504 formed inside of housing 409, gas passage holes 450 formed on a gas passge cylinder 413, a second vortex room 506 formed inside of a gas passge cylinder 413 for scrubbing liquid containing pollution substances from gas on the basis of centrifugal separating, finally the clean gas is discharged at a clean gas outlet 432 after scrubbing or centrifugal separating liquid containing pollution substances, as indicated by the arrows, on the basis of different specific gravity (1:1000, gas:liquid) at a 1^{st} vortex room 504 and a 2^{nd} vortex room 506. wherein a separate plate is disposed for separating a bearing 434 from a gas stream. meanwhile the liquid containing pollution substances is flowed with liquid passeges including first liquid drain holes 422 disposed on the bottom of a first vortex room 504, a second liquid drain hole 423 disposed on the bottom of a second vortex room 506, a liquid drain room 508 disposed inside of a liquid drain vessel 419. finally the liquid is discharged at a liquid drain trap 441 through liquid drain pipe 411 on the basis of gravity effect.

As shown in FIG. 12 is a perspective view of another embodiment for a mobile harmful dust purification apparatus according to the present invention, a flexible hose 604 is connected with a liquid atomizer 401 and an air-liquid centrifugal separator 407 through a gas suction duct 405, a grill 600 installed on the inlet of a flexible hose 604 for preventing larze size of granule in gas and for cleaning dust and harmful dust at a remote distance, especially for scrubbing dust or harmful gas at a remote distance in an industrial facility including the process of cast iron, precision machine, food, chemical stuff, grains, cement, asbestos, metal works. Wherein a flexible hose 604 is provided for reaching dust or harmfil gas at a remote distance with its long length and mobile.

Wherein grill 600 is provided for protecting gas liquid centrifugal separator by screening the large size of granule.

As shown in FIG. 13 is a perspective view of another embodiment for a chimney exhaust gas purification apparatus according to the present invention, a vortex cleaning room 703A is connected with an liquid atomizer 703, and an liquid atomizer 703, such as “an air-liquid jet nozzle”, is connected with an air-liquid centrifugal separator 407 through a gas suction duct 405, an air blower 794 connected with an vortex cleaning room 703A via an air-liquid nozzle jet 703 through a gas pipe, and a liquid supply pump 796 connected with a vortex cleaning room 703A through a liquid pipe, a liquid tank 701 connected with a liquid supply pump 796 through a liquid pipe, a liquid circulate pump 792 connected with a liquid tank 701 through a liquid pipe, a liquid cleaner 790, such as “centrifugal liquid cleaner”, connected with a liquid circulate pump 792 through a liquid pipe, a liquid drain trap 441 connected with a liquid cleaner 790 for cleaning exhaust gas of chimney in industrial facility.

Thus the exhaust gas stream of chimney mixed with numerous liquid droplets in the form of vortex flow at vortex cleaning room 703A, since the numerous liquid droplets are atomized or sprayed in the form of vortex flow with aid of a liquid atomizer 703, an air-liquid nozzle jet installed on an air blower 794 or compressor, therefore the mixed gas-liquid stream is flowed in a gas-liquid centrifugal separator 407 with the inducing power of a centrifugal impeller 408 rotating with an electric motor 433, and then the mixed gas-liquid stream is formed as centrifugal vortex stream, further the mixed gas-liquid stream is separated liquid containing pollution substances on the basis of different specific gravity (1:1000, gas:liquid) at a 1^{st} vortex room 504 and a 2^{nd} vortex room 506 as shown in FIG. 1.

Therefore, the liquid containing pollution substances is flowed downward with the gravity effect inside wall of a housing 409 as shown in FIG. 1, wherein the liquid containing pollution substances is not blown out together in discharging clean gas stream due to the aqua viscosity, thus the liquid containing pollution substances is gathered with gravity effect at a liquid drain trap 441, meanwhile the clean gas is discharged in air through a clean gas outlet 432 via plurality of gas passage holes 450 without leaking through a liquid drain trap 441 as same as described in above statement.

Further liquid containing pollution substances is gathered in a liquid cleaner 790 for separating pollutant substances in liquid, wherein a liquid cleaner 790 means comprises centrifugal liquid separator with cleaning liquid centrifugal power, or conventional solid filters et al. for conserving environment on green earth, and clean liquid is conveyed with a circulation pump 792 from a liquid cleaner 790 to a liquid tank 701 through a pipe for reusing, and clean liquid is conveyed with a liquid supply pump 796 from a liquid tank 701 to a liquid atomizer 703 as in gas-liquid jet nozzle through a pipe for atomizing again. Wherein a grill 700 is provided for preventing the large size of granule.

As shown in FIG. 14 is a perspective view of another embodiment for an automobile turbo charger suction air purification apparatus according to the present invention, an air-liquid centrifugal separator 807 is disposed with a suction grill 800 on the air inlet of an automobile internal engine, a centrifugal impeller 808 is supported with a bearing 834 above a separte plae 860 at an air suction inlet 831 inside of a housing 809, a centrifugal impeller 808 connected with a turbine 833A in an exhaust gas pipe 804 of engine through an impeller shaft 835, a liquid atomizer 803 and a grill 800 installed on the front of an air-liquid centrifugal separator 807 through an air suction duct 805, an air passage cylinder 813 is disposed inside of an air-liquid centrifugal separator 807, several air passage holes 850 is formed on the circumference side of an air passage cylinder 813, an air exit pipe duct 832 is installed on the side of an air passage cylinder 813, a first liquid drain holes 822 is formed on the bottom of an air passage cylinder 813, a liquid drain vessel 819 is disposed on the bottom of an air passage cylinder 813, a liquid drain trap 841 is installed on the bottom of a liquid drain vessel 819, and a first vortex room 804 is provided annually inside of a housing 809, a second vortex room 806 is provided inside of an air passage cylinder 813, and a liquid filter 890 is connected with a liquid drain trap 841 through a pipe, a liquid circulate pump 892 is connected with a liquid filter 890 through a pipe, a liquid tank 801 is connected with a liquid circulate pump 892 through a pipe, a liquid atomizer 803 is connected with a liquid tank 801 through a liquid pipe 802 as an Wet type air cleaner utilizing a centrifugal for cleaning suction air of turbo charger.

Conventional turbo charger for the internal engine of an automobile has two classifications into turbo charger using ‘exhaust gas stream’ and super charger using ‘electric power from battery’, however both of all are used with solid filter element for cleaning inlet air. Thus it has low purification efficiency problem with clogging and a serious of environment pollution with an abolished solid filter element.

Thus it is composed of a first vortex room 804 provided annually between housing 809 and an air passage cylinder 813, a second vortex room 806 provided inside of an air passage cylinder 813 on the structure of turbo charger for cleaning inlet air without a solid filter element.

Therefore, a turbine 833A is rotated with the rotation power of exhaust gas (3-5 atmospheric pressure) from an internal engine in the case of turbo charger or an electric motor in the case of super charger; a centrifugal impeller 808 connected with a turbine 833A through a shaft 835 is rotated with a high speed.

Further the atomized liquid droplets is atomized or sprayed in the form of vortex flow with aid of a liquid atomizer 803, therefore the mixed air-liquid stream is flowed in an air-liquid centrifugal separator 807 with the inducing power of a centrifugal impeller 808, and then the mixed air-liquid stream is formed as centrifugal vortex stream, further the mixed air-liquid stream is separated liquid containing pollution substances on the basis of different specific gravity (1:1000, gas:liquid) at a 1^{st} vortex room 804 and a 2^{nd} vortex room 806.

Therefore, the liquid containing pollution substances is flowed downward with the gravity effect inside wall of a housing 809, wherein the liquid containing pollution substances is not blown out together in discharging clean gas stream due to the aqua viscosity, the liquid containing pollution substances is gathered with gravity effect at a liquid drain trap 841, meanwhile the clean gas is discharged in air through clean air outlet 832 via plurality of air passage holes 850 without leaking through a liquid drain trap 841 as same as described in above statement.

Further liquid containing pollution substances is passed in a liquid filter 890 for separating pollutant substances in liquid, and clean liquid is conveyed with a liquid circulate pump 892 from a liquid filter 890 to a liquid tank 801 through a liquid pipe 891 for reusing and for atomizing again, thus it is provided for a small amount of liquid in an automobile for a long time without refilling liquid according to this invention. Wherein a grill 800 is provided for preventing the large size of granule.

As shown in FIG. 15 is a perspective view of another embodiment for an automobile exhaust gas purification apparatus according to the present invention, a gas-liquid centrifugal separator 807 is connected with an exhaust gas pipe 904 from an internal engine at a gas suction inlet 931, a centrifugal impeller 908 is disposed inside of a gas-liquid centrifugal separator 807, a centrifugal impeller 908 is connected with a turbine 933A in an exhaust gas pipe 904 of engine through an impeller shaft 935 and a bearing 934 installed on a gas separate plate 960, a liquid atomizer 903 is installed on the front of a gas-liquid centrifugal separator through an exhaust gas suction duct 905, a gas passage cylinder 913 is disposed inside of a gas-liquid centrifugal separator 907, several gas passage holes 950 are formed on the circumference side of a gas passage cylinder 913, a clean gas outlet 932 is installed on the side of a gas passage cylinder 913, a first liquid drain holes 922 is formed on a liquid drain plate 924 in the bottom of a gas passage cylinder 913, a second liquid drain hole 923 is formed on a liquid drain plate 924 in the bottom of a gas passage cylinder 913, a liquid drain vessel 919 is disposed on the bottom of a gas passage cylinder 913, a liquid drain trap 941 installed on the bottom of a liquid drain vessel 919, and a first vortex room 904 is provided annually between a housing 909 and a gas passage cylinder 913, a second vortex room 906 is provided inside of a gas passage cylinder 913, and a liquid filter 990 is connected with a liquid drain trap 941 through a liquid drain pipe 911, a circulate pump 992 connected with a liquid filter 990 through a liquid pipe 991, a liquid tank 901 connected with a circulate pump 992 through a pipe, a liquid atomizer 903 connected with a liquid tank 901 through a pipe for cleaning the exhaust gas from automobile engine.

Therefore, a turbine 933A is rotated with the rotation power of exhaust gas (3-5 atmospheric pressure) from an internal engine as same as a turbo charger; Thus a centrifugal impeller 908 is rotated with a high speed since a centrifugal impeller 908 is connected with a turbine 933A through an impeller shaft 935.

Thus the exhaust gas stream from an internal engine mixed with the atomized liquid droplets in the form of vortex flow at scrubbing room, inside of a gas suction duct 905, since the atomized liquid droplets is atomized or sprayed in the form of vortex flow with aid of a liquid atomizer 903 as in venturing tube, therefore the mixed gas-liquid stream is flowed in a gas-liquid centrifugal separator with the inducing power of a centrifugal impeller 908, and then the mixed gas-liquid stream is formed as centrifugal vortex stream, further the mixed gas-liquid stream is separated liquid containing pollution substances on the basis of different specific gravity (1:1000, gas:liquid) at a 1^{st} vortex room 904 and a 2^{nd} vortex room 906.

Therefore, the liquid containing pollution substances is flowed downward with the gravity effect inside wall surface of a housing 909, wherein the liquid containing pollution substances is not blown out with a discharging clean gas stream due to the aqua viscosity, the liquid containing pollution substances is gathered with gravity effect at a liquid drain trap 941, meanwhile the clean gas is discharged in air through clean gas outlet 932 via plurality of gas passage holes 950 without leaking through a liquid drain trap 941 as same as described in above statement.

Further liquid containing pollution substances is passed in a liquid filter 990 for filtering pollutant substances in liquid, and clean liquid is conveyed with a liquid circulate pump 992 from a liquid filter 990 to a liquid tank 901 through a liquid pipe 991 for reusing, and clean liquid is atomized with an liquid atomizer 903, especially a venturing tube or a ultrasonic vibration through a pipe 902 for atomizing again and so on, thus it is provided for a small amount of liquid in an automobile for a long time without refilling liquid according to this invention.

Wherein said gas comprises air, vapor, ammonia, nitrogen, hydrogen, ozone and oxygen et al. in the form of continuous gases, and liquid comprises water, lubricant oil, rust, dust and carbonated material et al.

Finally wet type air cleaner utilizing a centrifugal impeller according to the present invention may be installed and operated with a complex air cleaner or air conditioning system for utilizing gas-liquid centrifugal separation efficiency.

### INDUSTRIAL APPLICABILITY

Wet type air cleaner utilizing a centrifugal impeller with a liquid sprayer and gas-liquid centrifugal separator for cleaning gases, especially air is achieved for more than 99% air purification efficiency with the aqua viscous cohesion of fme water droplets in the positive 3 dimensional vortex flow, neutralization reaction with harmful gaseous substances, especially on the basis of natural water H₂O, centrifugal separating on the basis of different specific density, especially air to water 1 to 1000, automatic sterilization without chemical addicts.

As a result, it is applicable for fresh air in hospital facility including baby room, aseptic surgery, and patient room, automobile, home appliances, office, and school, and industrial facility for semi conduct manufacturing, chemical process, clean room, aseptic laboratory, and military tools for chemical, biological and radiological (CBR) warfare including a personal soldier, a bunker, a tank et al.

The gas-liquid centrifugal separator may be provided for the auxiliary part of a complex air cleaner and air condition system.

### SEQUENCE LISTING

Optional Blank

1-13. (canceled)

14. Wet type air cleaner utilizing a centrifugal impeller comprising: a body 407 in which a centrifugal impeller 408 rotates the sucked air, to which a housing and a gas passage cylinder 413 are mounted so that a vortex having a centrifugal force lengthwisely passes by a predetermined distance, the body 407 having an annular first vortex room formed between the housing 409 and the gas passage cylinder 413 and a second vortex room 506 formed in the gas passage cylinder 413; a gas suction duct 405 mounted to the front side of the body 407, through which air is moved; and a liquid tank 401 communicated with the gas suction duct 405, for supplying the washing water to the gas suction duct 405 from a liquid atomizer 403 through a venturi tube 402, wherein the contaminated substances in the air introduced through the gas suction duct 405 are collected by using the washing water and the air is purified by centrifugal separation by using the difference between the specific gravities of the air and the washing water.

15. A wet type air cleaner as claimed in claim 14, comprising: a body 407 having a separation plate 460 provided in the interior thereof, a motor 433 fixed to an upper portion of the separation plate 460, a centrifugal impeller 408 installed at the motor 433 so as to be rotated through a bearing 434 and a rotational shaft 435, a gas passage cylinder 413 to which the motor 433 and the bearing 434 are fixed in the housing 409, a plurality of openings 450 formed on the circumferential surface of the gas passage cylinder 413, a clean gas outlet 432 installed at an lower portion of the gas passage cylinder 413, a water discharging opening 423 installed at a lower portion of the gas passage cylinder 413, a water discharging tube 419 located at a lower portion of the air discharging tube 424, a trap 441 installed through a water discharging opening 411 at a lower portion of the water discharging tube 419, an annular first vortex room formed between the housing 409 and the gas passage cylinder 413 so that a vortex having a centrifugal force lengthwisely passes by a predetermined distance, and a second vortex room 506 formed in the gas passage cylinder 413, wherein a liquid atomizer 403 is mounted to the venturi tube 402 and a protection grill 400 is provided at an inlet opening of the gas suction duct.

16. A wet type air as claimed in claim 14, comprising: spiral grooves 416 formed on the outside surface of a gas passage cylinder 413 for generating vortex stream of wet gas on the basis of labyrinth effect and separating washing water from gas on the basis of centrifugal force.

17. A wet type air as claimed in claim 14, comprising: an over driver 436 utilized with the various transfer means including an oil surface friction transmission, a gear transmission et al. for increasing the rotation speed of a centrifugal impeller 408.

18. A wet type air cleaner as claimed in claim 14, comprising: a scrubbing room 406 located on the gas suction duct 405 for scrubbing gas pollutants with the stream of a fine particular liquid mist.

19. A wet type air cleaner as claimed in claim 14, comprising: an axial fan, a climbed fan and sirocco as a centrifugal impeller 408 for suctioning the stream of the wet air.

20. A wet type air cleaner as claimed in claim 14, comprising: a body 407 utilizing for an auxiliary parts in a dehumidifier of compressed air system, refrigerative air conditioner, constant temperature and humidity controller.

21. A wet type air cleaner as claimed in claim 14, comprising: a humidity controller 442 installed on a clean gas outlet 432 for adjusting the humidity of fresh gas.

22. A wet type air cleaner as claimed in claim 14, comprising: a liquid atomizer 403 utilized with the various atomizing means including a venturing tube, an ultra sonic vibration generator, and an air-liquid jet nozzle et al., and a liquid atomizer 403 installed with a liquid circulation pump disposed from a liquid drain trap 441 to a liquid tank 401 through a liquid pipe, and a liquid atomizer 403 installed with vortex generating means for generating a strong vortex stream of fine liquid droplet inside of gas suction duct 405.

23. A wet type air cleaner as claimed in claim 14, comprising: a centrifugal impeller 408 utilized with a turbine impeller for generating centrifugal vortex stream in a gas-liquid centrifugal separator 407.

24. A wet type air cleaner as claimed in claim 14, Wet type air cleaner utilizing a centrifugal impeller with a liquid atomizer and a gas-liquid centrifugal separator for disposing an electric motor outside of a gas-liquid centrifugal separator, comprising: an electric motor 433 installed on the outside of a gas-liquid centrifugal separator 407, an over driver 436 connected with an electric motor 433, an impeller shaft 435 rotatably fixed with an over driver 436, a centrifugal impeller 408 rotatably fixed on an impeller shaft 435, and a bearing 434 supported for a centrifugal impeller 408 on a gas passage cylinder 413.

25. A wet type air cleaner as claimed in claim 14, comprising: an impeller shaft 435 formed with an gas passage inside for passing a clean gas through inside of a shaft.

26. A wet type air cleaner as claimed in claim 25, Wet type air cleaner utilizing a centrifugal impeller with a liquid atomizer and a gas-liquid centrifugal separator for scrubbing dust and harmful gases at a remote distance, comprising: a flexible hose 604 connected with a liquid atomizer 401 in the front of an gas-liquid centrifugal separator 407 through a gas inlet duct 405.

27. A wet type air cleaner as claimed in claim 14, Wet type air cleaner utilizing a centrifugal impeller with a liquid atomizer and a gas-liquid centrifugal separator for cleaning the exhaust gas of chimney in industrial facility, comprising: a vortex cleaning room 703A disposed in the front of a gas-liquid centrifugal separator 407 through a gas suction duct 405, and a liquid atomizer 703 connected with a vortex cleaning room 703A through a pipe, an air blower 794 connected with a vortex cleaning room 703A through a pipe for operating an air-liquid jet nozzle, and a liquid supply pump 796 connected with a vortex cleaning room 703A through a liquid pipe, a liquid tank 701 connected with a liquid supply pump 796 through a liquid pipe, a liquid circulate pump 792 connected with a liquid tank 701 through a liquid pipe, a liquid cleaner 790 connected with a liquid circulate pump 792 through a liquid pipe, a liquid drain trap 441 connected with a liquid cleaner 790.

28. A wet type air cleaner as claimed in claim 14, comprising: a liquid atomizer and air-liquid centrifugal separator for cleaning the suction air of a turbo charger in an automobile engine, comprising: an air-liquid centrifugal separator 807 disposed with a grill 800 at the air inlet of an engine, a centrifugal impeller 808 supported with a bearing 834 inside of a an air-liquid centrifugal separator 807, a turbine 833A connected with a centrifugal impeller 808 through an impeller shaft 835, a liquid atomizer 803 disposed in the front of an air-liquid centrifugal separator 807 through an air suction duct 805, an air passage cylinder 813 disposed inside of an air-liquid centrifugal separator 807, several air passage holes 850 formed on the circumference side of an air passage cylinder 813, a clean air outlet 832 installed on the side of an air passage cylinder 813, a liquid drain plate 824 is installed on the bottom of a gas exhaust cylinder 813, a first liquid drain holes 922 formed on a liquid drain plate 824, a second liquid drain holes 823 formed on a liquid drain plate 824, a liquid drain trap 841 installed on the bottom of a liquid drain vessel 819, and a first vortex room 804 formed annually inside of a housing 809, a second vortex room 806 formed inside of an air passage cylinder 813, and a liquid filter 890 connected with a liquid drain trap 841 through a liquid pipe 891, a circulate pump 892 connected with a liquid filter 890 through a liquid pipe 891, a liquid tank 801 connected with a circulate pump 892 through a liquid pipe 891, a liquid atomizer 803 connected with a liquid tank 801 through a liquid pipe 891.

29. Wet type air cleaner utilizing a centrifugal impeller with a liquid atomizer and gas-liquid centrifugal separator for cleaning exhaust gas from automobile engine, comprising: a gas-liquid centrifugal separator connected with an exhaust gas pipe 904 of an engine, a centrifugal impeller 908 supported with a bearing 934 inside of a gas-liquid centrifugal separator, a turbine 933A connected with a centrifugal impeller 908 through an impeller shaft 935, a liquid atomizer 903 disposed in the front of a gas-liquid centrifugal separator 907 through an exhaust gas suction duct 905, a gas passage cylinder 913 located inside of a gas-liquid centrifugal separator 907, several gas passage holes 950 formed on the circumference side of a gas passage cylinder 913, a clean gas outlet 932 installed on the side of a gas exhaust cylinder 913, a liquid drain plate 924 is installed on the bottom of a gas exhaust cylinder 913, a first liquid drain holes 922 formed on a liquid drain plate 924, a second liquid drain holes 923 formed on a liquid drain plate 924, a liquid drain vessel 919 disposed on the bottom of a gas passage cylinder 913, a liquid drain trap 941 installed on the bottom of a liquid drain vessel 919, and a first vortex room 904 formed annually in a housing 909, a second vortex room 906 formed inside of an exhaust gas passage cylinder 913, and a liquid filter 990 connected with a liquid drain trap 941 through a liquid pipe 991, a liquid circulate pump 992 connected with a liquid filter 990 through a liquid pipe 991, a liquid tank 901 connected with a circulate pump 992 through a liquid pipe 991, a liquid atomizer 903 connected with a liquid tank 901 through a liquid pipe 991.
